(19) United States
(12) Patent Application Publication
(10) Pub. No.: US 2008/0029685 A1
(43) Pub. Date: Feb. 7, 2008

(54) METHOD OF CASTING A CONCRETE TRUSS

(76) Inventor: Mark William West, Winnipeg (CA)

Correspondence Address: ADE & COMPANY INC., 2157 Henderson Highway, WINNIPEG, MB, R2G1P9, CA

(21) Appl. No.: 11/770,174

(22) Filed: Jun. 28, 2007

Related U.S. Application Data
(60) Provisional application No. 60/817,690, filed on Jul. 3, 2006.

(51) Int. Cl. B28B 7/06

(52) U.S. Cl. 249/50

(57) ABSTRACT

Complex, three-dimensional, variable section casts with a high level of dimensional control can be made from molds consisting of two flat or tailored sheets of flexible material (such as fabric) held between rigid clamps. The clamping materials control the shape and dimension of the mold in the X and Y directions while the flexible sheets are allowed to deflect in the Z direction. Void shapes in the truss can be obtained when the clamping material presses the two sheets together.

This application claims the benefit under 35 U.S.C. 119 of the filing date of Provisional Application Ser. No. 60/817,690 filed Jul. 3, 2006.

This invention relates to a method of forming precast RC trusses and light-weight variable section beams, precast and cast-in-place variable section RC columns and walls, and other cast concrete components for structural, architectural, and/or industrial applications.

### BACKGROUND OF THE INVENTION

Flexible formworks have been used commercially for on-grade and underwater applications for over thirty years. Commercial development of above- ground applications is more recent: Currently, one company (Fab-Form Industries, Surrey BC) manufactures and markets fabric formwork to the construction industry (foundation footing and column forms). Japanese architect Kenzo Unno has developed a fabric formwork system for cast-in-place RC walls. Academic research by Mark West has developed fabric formwork methods for manufacturing cast-in-place and precast RC columns, beams, and panels, including methods for producing high efficiency variable-section structures that significantly reduce material, dead weight and embodied energy.

### SUMMARY OF THE INVENTION

It is one object of the invention to provide a novel method of forming a concrete truss of the above type.

According to one aspect of the invention there is provided a method of manufacturing concrete trusses comprising:

providing a plurality of mold members which connect together to define a cavity arranged to shape poured concrete into a truss of a required shape;

the cavity being shaped to define for the truss a top flange cavity to form from the poured concrete a top flange extending between two ends of the truss;

the cavity being shaped to define for the truss a bottom flange cavity to form from the poured concrete a bottom flange extending generally longitudinally;

the cavity being shaped to define for the truss a plurality of upstanding strut cavities to form from the poured concrete a plurality of struts extending between the top and bottom flange cavities;

at least one of the mold members defining a bottom surface for the bottom flange cavity of the truss;

the mold members being shaped to define closed areas which are located between the strut cavities, above the bottom flange cavity and below the top flange cavity which prevent the entry of concrete to form in the truss openings between the posts;

and forming the cavities of the mold members from rigid members and from fabric where the surfaces for the cavities are partly defined by the rigid members and partly by the fabric;

the fabric being stretched over the rigid members such that the fabric contacts the rigid members at contact parts thereof and the fabric is spaced from the rigid members at other parts thereof so as to form curved sections in the fabric as the fabric bridges over the other parts to the contact parts;

and forming curved sections in the truss at least on sides of the struts of the truss by shaping the poured concrete in the curved sections in the fabric.

Preferably the bottom flange cavity of the truss is shaped to define a bending moment curve for the truss.

Preferably the mold members include two side members which are pressed together on each side of the truss to be formed to form at least part of the cavities therebetween and wherein each of the side members is formed by rigid parts and fabric covering or between the rigid parts.

Preferably each of the side members has an inner cavity forming surface defined by rigid portions which locate the mold surfaces in directions longitudinal to the truss and vertically of the truss to define x and y plane and wherein between the rigid portions the surface is defined by the fabric which is smoothly curved between the rigid portions.

Preferably the side members have protruding portions such that the protruding portions of one side member project toward the raised portions of the other side member so as together to cooperate to define the closed areas with side edges of the raised portions defining the side edges of the truss openings and wherein the fabric is located on at least some of side edges of the raised portions so as to smoothly curve the truss away from the side edge.

Preferably each side member is covered by a single sheet of fabric. However individual pieces of fabric can be located in the areas between the rigid mold parts. The pieces of fabric may be connected using tailoring techniques well known to provide a required shaping. A The single piece allows easier fastening around the back of the mold part but the individual pieces, or the tailored and connected pieces of fabric can also be fastened to the back of the mold part using staples or other simple fastening elements. The molds can be made with a single flat sheet of fabric, either coated or uncoated. Three-dimensional tailoring, i.e. a membrane composed of differently shaped parts connected together, is also an option, though obviously more complex and involved.

Preferably the fabric is pulled around the back of the rigid mold members and fastened to a face of the rigid mold member facing away from the cavity.

Preferably the method includes shaping the fabric using tension to pull the fabric to a required location and fastening the fabric to the mold member.

Preferably the method includes shaping the fabric using a gauge to measure a required location of the fabric relative to rigid portions of the mold members.

Preferably the method includes shaping coated fabrics using heat to aid stretching.

Preferably the method includes providing reinforcing tension members in the tension zone areas of the beam, which may not be in the bottom depending on the truss design.

Preferably the mold members include a base member having an upper surface defining a bottom surface of the bottom flange and two side members which are arranged each on a respective side of the cavity.

Preferably the method includes providing reinforcing tension members along the tension zone areas of the beam wherein the reinforcing tension members are inserted within the space defined by the base member with one of the side members in place to define a receptacle for the tension members.

Conventional flexible formworks can only cast members with pure tension curves in all three dimensions. This method allows far greater geometric control of fabric-cast concrete members using an easily constructed formwork rig. Rigid clamps are used, that is any rigid formwork member that holds, or pinches, the fabric, holding the two membrane layers, to precisely control the X and Y dimensions of the cast to any desired geometry. The membrane is free to deflect only in the Z direction, allowing the formation of complex double curvature shapes. Casts with complex void shapes can also be easily formed. Traditional rigid formwork constructions can be used to support clamping elements. No special tools or scaffolding is required. Formwork constructions can be folded and transported. Sewing, heat sealing, or other tailoring is generally not required. Tailored sheets may be used, though are not preferred for simplicity of construction.

Thus the parts of the mold are:

A center piece shaped so that its top edge follows the longitudinal shape of the truss's bottom flange or profile, bearing in mind that the bottom edge of some truss shapes may not be a ‘flange’ proper.

Two rigid side pieces with the above protruding portions attached which are shaped to act as “Block-Out Clamps”.

Two flat, or possibly tailored sheets of fabric, or other flexible membrane material, to cover the two side pieces and Block-Out Clamps.

The method is as follows:

The two flat sheets of fabric are stretched over the Block-Out Clamps and rigid side pieces to form a continuous surface over each side piece assembly. The side pieces thus covered are placed on either side of the central piece.

The covered side pieces are pushed against either side of the center piece. This causes the top edge of the center piece to push (deflect) the stretched fabric sheets back against the rigid side-pieces, thus forming a gasketed seal along the top edges of the center piece, that is, along the entire length of the bottom of the mold. This forced deflection of the flexible membrane coverings also serves to further pre-tension the membrane coverings.

With one of the side pieces removed, tension reinforcing can be easily placed in the tension flange portion of the mold, or in other portions of the truss mold as required.

When the fabric-covered side pieces are in place, the Block-Out Clamps on either side touch each other thus clamping the two fabric sheets together (left and right) and forming the block-out pattern (i.e. the void shapes) in the cast truss. The joint formed between the pairs of pressed Block-Out Clamps can be sealed, if required/desired with a gasket material such as soft rubber.

The completed truss mold is filled with concrete. After the concrete has achieved its strength, the two side pieces are removed. The side pieces retain their stretched fabric coverings and are immediately ready for further casts after cleaning.

Tension reinforcing in rectangular trusses can be pre-stressed by pulling the reinforcing strands horizontally using hydraulic jacks or other mechanical means.

Tension reinforcing strands in curved, variable section trusses can be pre-stressed by pushing a fixed-length strand vertically downwards.

A variable section truss mold can also be used to form precast arches or arched trusses, that is, trusses curved along the top, by inverting a suitably reinforced variable section cast truss, that is, turning a cast truss “upside-down” with its reinforcing placed to suit the inversion of the structure.

A multitude of other truss designs can also be made using this method. For example: trusses for continuous trusses spanning over more than two supports, lenticular trusses, that is trusses with curved top and bottom flanges, etc.

### BRIEF DESCRIPTION OF THE DRAWINGS

One embodiment of the invention will now be described in conjunction with the accompanying drawings in which:

FIG. 1 is a side elevational view of the mold structure with one side mold member removed to show the interior cavity shape.

FIG. 2 is a cross sectional view of the mold structure along the lines 2-2 with the mold complete.

FIG. 3 is a cross sectional view of the mold structure along the lines 3-3 with the mold complete.

FIG. 3A is a cross sectional view of the mold structure along the lines 3-3 with one of the two side mold members removed.

FIG. 4 is a cross sectional view of the mold structure along the lines 4-4 with the mold complete.

FIG. 4A is a cross sectional view of the mold structure along the lines 4-4 showing a modified arrangement of the mold .

In the drawings like characters of reference indicate corresponding parts in the different figures.

### DETAILED DESCRIPTION

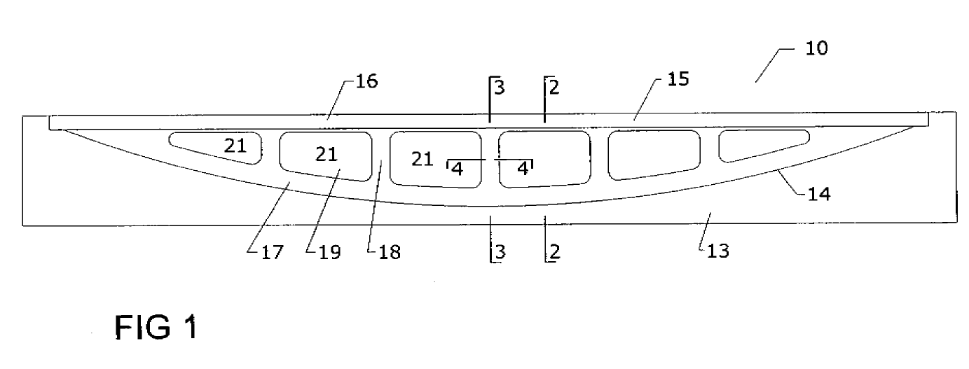

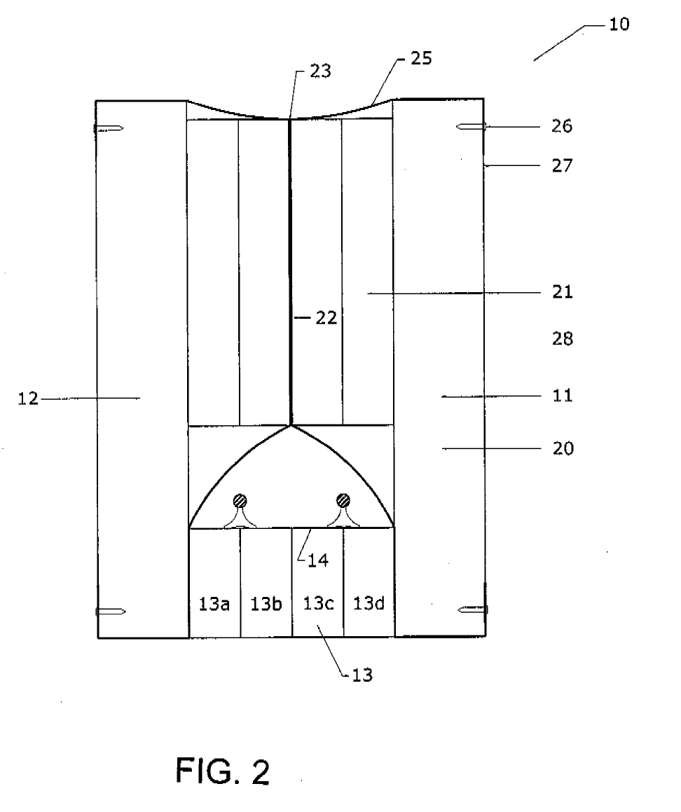

In the figures is shown a mold generally indicated at 10 which is formed from three mold parts best shown in FIG. 2 including a first side mold part 11, a second side mold part 12 and a base mold part 13. As shown in FIG. 1 the base mold part 13 provides an upper surface 14 which forms the bottom surface of the cavity generally indicated at 15. The cavity 15 (FIG. 1) is shaped to form the truss with which the present invention is concerned. The truss is of the type including a top flange, a bottom flange and a plurality of interconnecting struts where between each post and the next, the material is omitted to provide an opening. Thus the cavity includes an upper cavity portion 16 (FIG. 1) for the top flange, a bottom cavity portion 17 (FIG. 1) for the bottom flange and a plurality of cavity portions 18 (FIG. 1) each defining a respective one of the plurality of struts. Between each strut and the next, the mold members close off the cavity in the area indicated at 19 (FIG. 1) so that no material is formed in this area when the concrete is poured into the cavity of the mold.

In the example shown, the mold parts are formed from wooden panels fastened together so that the rigid center piece part 13 defines the structure and the inner surface 14. Other techniques can of course be used for forming molds. However one advantage of the present invention is that the mold can be readily constructed from the panels and the fabric so that mold cost is kept very low allowing custom manufacture and design of particular trusses for particular end uses strictly in accordance with engineering requirements without the necessity for compromise of the shape of the truss due to manufacturing requirements.

For a bi-axially symmetrical cast, each of the side mold parts 11 and 12 is substantially identical and arranges a mirror image so that the side mold parts can be clamped together on each side of the base mold part to form and enclose the cavity. Asymmetrical molds can also be easily made, though the utility of such molds may perhaps be questionable. The side mold part 11 is thus formed from a side plate 20 together with protruding portions 22 which define the opening 19. The protruding portions are again formed from panels of wood which are fastened to the inside surface of the outer plate 20. Thus as shown in FIG. 2 the raised portions 21 have an inside surface 22 with the inside surfaces butting at the longitudinal center plane of the mold. This acts to form an area 23 between the mold parts which exclude the poured material to form the openings 19.

Each of the side mold parts is covered by a layer of fabric 25. The fabric is attached by fasteners 26 to the back surface 27 of the mold part and the fabric extends over the front surface of the mold covering the inside surface 28 of the side plate 20 and covering the surfaces 22 of the protruding portions 21 which act as a stand-off structure supporting pinch-plate 22.

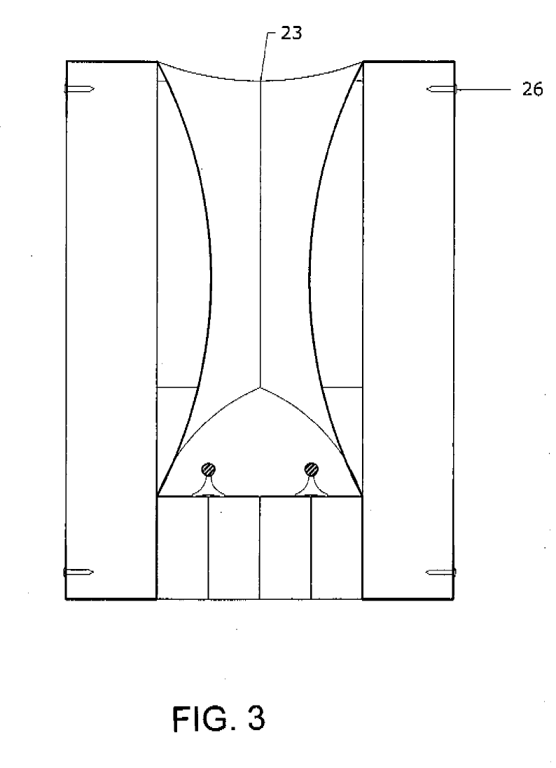

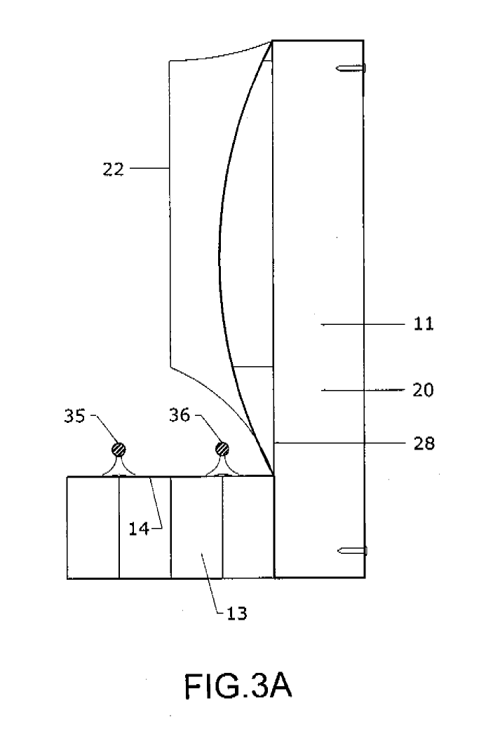

As shown in FIG. 3A, the mold is first partly assembled by attaching the side part 11 to the base part 13 by a clamping system schematically indicated at 28. This forms one half of the cavity with the second side 12 removed leaving one side of the cavity open.

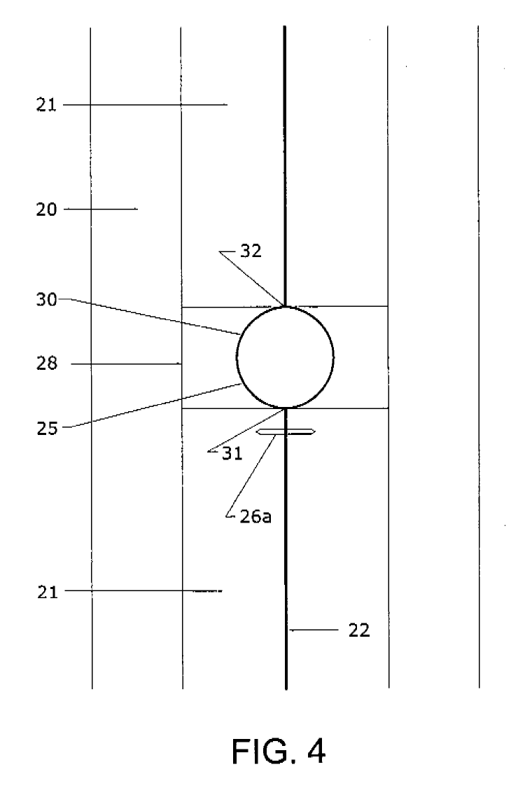

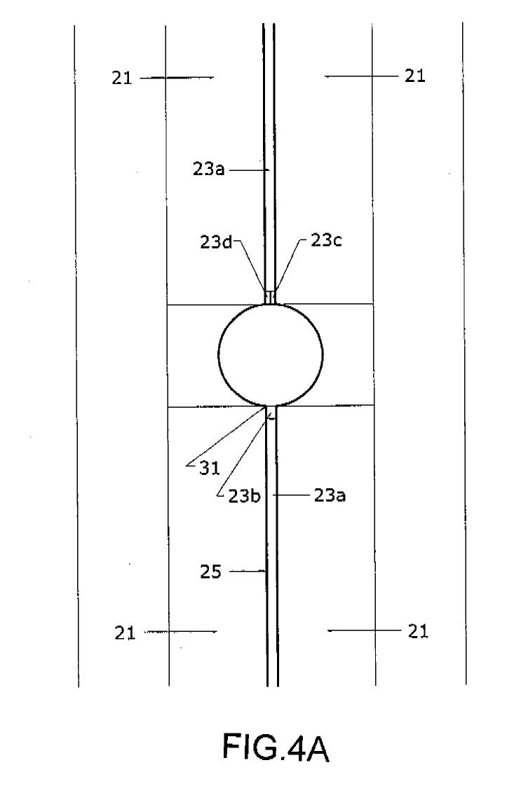

As shown in FIGS. 3A and 4, between the projecting portions 21, the fabric 25 is draped into a curved portion 30 between the edges 31 and 32 of adjacent ones of the raised portions 21. The fabric extends in this draped section to a position close to the surface 28 of the outer plate 20. The fabric is preferably spaced away from the surface 28 but may bottom out against the inside surface 28 of the outer plate 20. Thus the fabric forms the smooth curve between the edges 31 and 32 in both the horizontal plane as shown in FIG. 4 and also in the vertical plane as shown in FIG. 3A. The fabric is pulled into place by tensioning and also by the use of depth gauges which determine or measure the depth of the curved section 30 between the edges 31 and 32. The gauge sets the length of fabric fed into the space 30. This is done prior to tensioning. Setting the fabric length with a gauge sets the final deflection geometry that will be formed after tensioning this section of the fabric. The fabric is pulled in the unsupported areas between pinch-plates 22, that is in the areas of the struts.

The fabric is fastened to the outer surface of the side mold part and may be fastened by fasteners 26A to the outer surface 22 of the raised portion 21 near the edges of the space 304 Thus the fabric is held in place and located by the raised portions but between the raised portions the fabric is free to curve under tension to the required position. The fabric is pulled by the mold maker to the required curvatures and is held in place by the tension of the fabric which is applied by the positioning of the fasteners 26 and 26A.

The curvature of the fabric forms smooth curves on the outside surface of the concrete when poured to avoid sharp edges and sharp lines which can concentrate stresses and form cracks. The positioning of the fabric reduces the amount of concrete between the raised portions so that the proper curvature of the surfaces can be provided to transfer the loads effectively through the concrete structure. As is previously known, the most efficient longitudinal shape for a beam is that in which the beam's depth varies in proportion to its applied bending moment across its span. For a uniformly distributed load, this shape will be a parabolic curve. However other shapes can be provided which are either smoothly curved or have straight sections between the struts or load points. It will be appreciated that a truss of this type is in compression throughout its structure except at the bottom surface of the bottom beam in its tension zone areas. However, differently loaded and designed trusses may have tension in other parts of the beam—for example: a cantilever beam has tension along the top of the beam. At the tension location is provided tension members indicated at 35 and 36. These tension members can be formed of any suitable material such as steel. As shown in FIG. 3A, the tension members can be simply located in place using standard reinforcing bar supports or chairs placed across the surface 14. The chairs are used to locate the reinforcing some distance inside the outer surface of the cast so that the reinforcing material is protected from heat during fire. The dimension of this fire cover is set by building codes.

Alternatively the tension members can be pre-tensioned pre-attaching a fixed length of tension reinforcing material to either end of the mold and formed into the curvature required by locating members pressing down on the tensioning cables through the area within which the struts 18 are to be formed. Thus at each post a pressure member (not shown) is applied which presses down on the reinforcing rods or cables to pre-tension them and hold them in place above the surface 14 during the pour.

With the cables in place as shown in FIG. 3A the second side of the mold is added as shown in FIG. 3 so as to press the surfaces 22 together at the area 23 where the concrete is to be excluded. Turning now to FIG. 4A, an alternative arrangement for the exclusion zone indicated at 23A is provided in which there is provided a bead or gasket 23B located at the edge 31 of the raised portion 21 on top of the fabric. The bead thus pinches the fabric 25 at the edge 31 and more effectively prevents the penetration of the concrete into the area 23A. The use of the bead 238 is advantageous in avoiding the formation of a knife edge in the cast concrete where the fabric sections meet at the edge 31. Thus in FIG. 4, it will be noted that a sharpened edge of the concrete can be formed in the area where the fabric enters the area between the two raised portions 21. In the arrangement of FIG. 4A, the presence of the bead holds the fabric as a continuous smooth curve around the edge of the concrete post as it is formed at the junction between the two raised portions 21. At the top of FIG. 4A is shown one example where the gasket is attached to one surface of the fabric at the raised portions 21 and in the bottom is shown an alternative arrangement in which there are two beads 23C and 23D each attached to the fabric at a respective one of the raised portions 21. This bead or gasket material serves two functions: 1: it seals the joint between the raised portions, and 2: it shapes the mold cavity so that the concrete does not form a knife edge at the void openings of the truss. Concrete knife edge shapes chip easily. Standard construction and design practice will provide a certain thickness for any concrete edge to avoid easy chipping or fracture.

The objective of the arrangements described above is to create a beam that is structurally expressive of the bending moment for a specified loading condition, using a minimum amount of material while also minimizing the complexity of formation. A beam whose structural depth varies in proportion to its applied bending moment circumvents internal shear stresses. A beam of this type is essentially a light-weight open-web composite truss with a concrete compression flange and fire-proofed tension flange, formed to an efficient structural geometry. Other, more complex, beam types can be formed as well.

The formwork and techniques described below comprise a basic method which can be applied to the production of beams with various patterns of voids and struts, depending on the design load. Images included are taken from several generations of form.

The formwork in these examples is comprised of three main components; a catenary-shaped base, symmetrical fabric-covered web-forming sides, and if required pre-stressing devices for steel cable reinforcement. When assembled, the fabric-covered sides form a gasket seal with the base, and meet to create the open-web voids. The pre-stressing devices, if used, mount to the sides of the apparatus and allow the vertical adjustment of steel rod (or tubes) to create tension in the cable, the cable being held at either end of the beam.

The mold is formed using the following fabrication, assembly & techniques. The plywood base is cut to a bending moment curve of predetermined length and depth. This curve is scribed onto the two rectangular plywood sides as a reference for the creation of the void blocks, taking into account the thickness of the top and bottom flanges, vertical strut thickness, and corner radii to prevent stressed fabric tearing and to give integrity to the intersections. The void block-out assemblies are manufactured in pairs, each assembly with a depth being half the width of the base. The blocks are then fixed to the sides, ensuring alignment by sandwiching the sides and block together while fastening. The spaces between the blocks will form the vertical struts of the truss.

The two sides are now ready to be covered with fabric. As one example, a coated polyolefin woven fabric can be used; the coated side was used as the casting surface. The technique of affixing the fabric is key in achieving uniform thicknesses of the vertical struts. The fabric is stretched around the back of the form, beginning with the strut regions. A gauge can be used to measure a consistent depth, attaching the fabric on either side of the gap. Staples, screws or other fasteners are used to fix the fabric permanently. As one example, an uncoated woven polypropylene or polyethylene geotextile fabric can be used. As an alternate example, a coated woven polypropylene or polyethylene or glass fiber fabric can be used. Other fabrics can be used as well, of course. The fabric is stretched around the back of the form, beginning with the strut regions at the center of the span, and working outwards towards the support regions of the span. A depth gauge can be used to measure a consistent depth, stapling, or otherwise attaching the fabric on either side of the gap. Attention to the symmetry of the curvature created is important. Repeating this process on the other strut regions, working from the center outward to ensure symmetry, creates the strut forms. The remaining loose fabric is then stretched and attached by stables or other means in the same fashion eliminating wrinkles by varying the angle of pull. When using a coated polyolefin fabric, or other plastic membrane, heat can be applied selectively to wrinkled areas to allow stretching to produce smooth tension curves across the mold wall surface. When applying the fabric to the opposite side, comparisons should be made regularly to verify symmetry.

Formwork or edging for the top flange can now be attached to the sides. The term clamping is used here as a generic term for attachment of the side. Clamping the open side to the base or center piece creates half of the hollow cavity of the mold, and provides a space for the installation of the reinforcing steel and tensioning mechanisms.

The beam is reinforced by tension reinforcing placed in the tension flange. This reinforcing may be pre-tensioned by vertical posts located at the loading points of the truss design, that is at the struts.

Attachment of the cable at each end is achieved by clamping either end of the cable to the ends of the rigid mold structure. The clamps are fixed to the base, braced by the compression block side forms. The length of the tension cable is determined so that when the cable is depressing downwards at the truss load points, the cable will be stretched into position in the tension flange of the truss, thus pre-stressing the cable within the mold. The ends need to be clamped ensuring even tension between the individual strands of the cable, and overall symmetry.

The pre-tensioning devices may be located over the designed loading points of the beam (vertical struts) and may be attach to the rigid mold components or to any other resistant attachment for example a floor. Threaded or hydraulically controlled rods press down on the reinforcing steel thus tensioning the cable. Once the rods are at the proper depth, the remaining side can be clamped onto the assembly. Alignment of the two sides should be checked. The vertical steel should be plumb and well aligned as this will ensure that the cable follows a straight path from end to end.

During pouring, the form should be leveled and secure. Pouring should begin at or near the center, moving outwards until the voids are full but not the compression block. The technique for removing air bubbles is most successful by continuously vibrating the apparatus while pouring. Continuing to vibrate while the compression block is poured ensures that any trapped air will escape. Alternatively self compacting concrete can be used.

Another example is the “fish” truss which is a hybrid of a tension-cable structure and an arch.

The techniques and formwork are similar to those of the above described truss, with identical reinforcement and pouring technique.

The plywood base is scribed with a catenary curve just as the previous beam. The curve is inverted and overlaid to create the pattern for the arch element. There is a slight difference in the blocking pattern to account for the integrated arch, but otherwise the formwork is created in the same manner.

To form the “fish tail” sections of the beam, void blocks are placed at each end, held in place by fastening through the form side. These blocks are easily removed after the bean has been lifted from the form.

Several methods of mold construction are possible. While the side pieces of the scaled models and full-scale prototype shown are made of plywood, these side pieces could be constructed using other materials or constructed as solid panels or as open frames. The Block-Out Clamp shapes may be constructed as panels held off the surface of the side piece frame, or alternately, just the perimeter of the Block-Out Clamp shapes may be constructed. Clamping pressure to hold the two side pieces of the mold together could be gained by a variety of mechanical means including treaded rods, bolts, or wedges, or in larger constructions, hydraulic pistons.

A variety of coated and uncoated structural fabrics could be used. Options include woven polyethylene or polypropylene textiles, or woven glass fibre textiles with an impervious and robust coating (ex. Teflon, PVC).

Many different truss designs can be constructed by this method by altering the shape of the center piece and the shapes and patterns of the Block-Out Clamps.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of manufacturing concrete trusses comprising:
providing a plurality of mold members which connect together to define a cavity arranged to shape poured concrete into a truss of a required shape;
the cavity being shaped to define for the truss a top flange cavity to form from the poured concrete a top flange extending between two ends of the truss;
the cavity being shaped to define for the truss a bottom flange cavity to form from the poured concrete a bottom flange extending generally longitudinally;
the cavity being shaped to define for the truss a plurality of upstanding strut cavities to form from the poured concrete a plurality of struts extending between the top and bottom flange cavities;
at least one of the mold members defining a bottom surface for the bottom flange cavity of the truss;
the mold members being shaped to define closed areas which are located between the strut cavities, above the bottom flange cavity and below the top flange cavity which prevent the entry of concrete to form in the truss openings between the posts;
and forming the cavities of the mold members from rigid members and from fabric where the surfaces for the cavities are partly defined by the rigid members and partly by the fabric;
the fabric being stretched over the rigid members such that the fabric contacts the rigid members at contact parts thereof and the fabric is spaced from the rigid members at other parts thereof so as to form curved sections in the fabric as the fabric bridges over the other parts to the contact parts;
and forming curved sections in the truss at least on sides of the struts of the truss by shaping the poured concrete in the curved sections in the fabric.

2. The method according to claim 1 wherein the bottom flange cavity of the truss is shaped to define a bending moment curve for the truss.

3. The method according to claim 1 wherein the mold members include two side members which are pressed together on each side of the truss shaped cavity to form at least part of the cavities therebetween and wherein each of the side members is formed by rigid parts and fabric covering the rigid parts.

4. The method according to claim 3 wherein each of the side members has an inner cavity forming surface defined by rigid portions which locate the mold surfaces in directions longitudinal to the truss and vertically of the truss to define x and y axes and wherein between the rigid portions the surface is defined by the fabric which is smoothly curved between the rigid portions.

5. The method according to claim 3 wherein the side members have raised portions such that the raised portions of one side member project toward the raised portions of the other side member so as together to cooperate to define the closed areas with side edges of the raised portions defining the side edges of the truss openings and wherein the fabric is located on at least some of side edges of the raised portions so as to smoothly curve the truss away from the side edge.

6. The method according to claim 3 wherein each side member is covered by a single sheet of fabric.

7. The method according to claim 3 wherein each side member is covered by tailored sheets of fabric.

8. The method according to claim 1 wherein the fabric is pulled around the back of the mold members and fastened to a face of the mold member facing away from the cavity.

9. The method according to claim 1 including shaping the fabric using tension to pull the fabric to a required location and fastening the fabric to the mold member.

10. The method according to claim 1 including shaping the fabric using a gauge to measure the length of the fabric and a required location of the fabric relative to rigid portions of the mold members.

11. The method according to claim 1 including shaping the fabric using heat to cause stretching.

12. The method according to claim 1 including providing at least one reinforcing tension member arranged along a tension zone of the truss.

13. The method according to claim 12 wherein the tension zone is along the bottom surface of the bottom flange.

14. The method according to claim 1 wherein the mold members include a base member having an upper surface defining a bottom surface of the bottom flange and two side members which are arranged each on a respective side of the cavity.

15. The method according to claim 14 including providing at least one reinforcing tension members along at least one respective tension zone area of the bottom flange wherein the at least one reinforcing tension member is inserted along tension zone areas of the bottom flange with one of the side members in place to define a receptacle for the at least one tension member.
